(19) United States
(12) Patent Application Publication
(10) Pub. No.: US 2010/0114918 A1
(43) Pub. Date: May 6, 2010

(54) GENERATION OF DEGENERATE SEQUENCES AND IDENTIFICATION OF INDIVIDUAL SEQUENCES FROM A DEGENERATE SEQUENCE

(75) Inventors: Bjarte Karlsen, Nesttun (NO); Øyvind Kommedal, Paradis (NO); Øystein Sæebø, Bergen (NO)

Correspondence Address: KNOBBE MARTENS OLSON & BEAR LLP, 2040 MAIN STREET, FOURTEENTH FLOOR, IRVINE, CA, 92614, US

(73) Assignee: ISENTIO AS, Bergen (NO)

(21) Appl. No.: 12/439,678

(22) PCT Filed: Sep. 5, 2007
(86) PCT No.: PCT/NO07/00314

§ 371 Date: Oct. 23, 2009

(30) Foreign Application Priority Data
May 31, 2007 (DK) PA 2007 00782

(51) Int. Cl. G06F 17/30; G06N 3/12

(52) U.S. Cl. 707/754; 707/760; 706/13; 707/E17.017; 707/E17.05

(57) ABSTRACT

The invention relates to identification of individual nucleic acid sequences from a mixed nucleic acid population. A typical application is to determine the bacteria present in sample containing a mix of several different bacteria. Present techniques require initial cultivation of the mixed bacteria sample and manual separation of the bacteria prior to sequencing. The invention allows for identification of the different bacteria by direct sequencing of the mixed bacteria sample without prior cultivation and separation. One aspect of the invention relates to generating a degenerate sequence from a chromatogram obtained by sequencing a mixed bacteria sample. Another aspect relates to base-calling, i.e. identification of individual sequences making up the degenerate sequence from the mixed bacteria sample. In this aspect, the degenerate sequence is divided into degenerate subsequences from which query subsequence combinations are generated. Then each query subsequence combination is aligned against target sequences present in a database. From these alignments, the target sequences present in the database are assigned an overall score which is used to determine which individual sequences were present in the mixed bacteria sample.

### FIELD OF THE INVENTION

The present invention relates to identification of individual nucleic acid sequences from a mixed nucleic acid population. The mixed nucleic acid population can e.g. be derived from a sample obtained in a clinical setting from a patient that is suspected to carry a bacterial infection.

### BACKGROUND OF THE INVENTION

Today, routine identification is typically done by cultivation of the sample, followed by manual separation of the different bacteria from solid agars. After separation the different bacteria are run through a battery of different biochemical tests, to establish their phenotypical characteristics. Based on these results it will be possible with variable degree of certainty to identify the bacteria in the sample. The main benefit of this method is the low cost. On the other hand it is very time consuming. Typically, a sample analysis needs 2-5 working days, often more. In addition, the identification will often be approximate. Furthermore, dead bacteria (due to antibiotic treatment of the patient prior to the sample collection, exposure to oxygen for anaerobe bacteria, long transportation time to the laboratory etc.) will not be detected at all by this method. Some bacteria also exhibit special growth requirements that make them very inconvenient for cultivation.

Bacteria can also be detected and identified by a PCR reaction. This method can identify dead bacteria as long as some of their DNA still remains in the sample. However, each PCR reaction is only able to detect one specific predefined bacterium giving you a “yes” or “no” answer. This means, that given a random clinical sample, you would have to run one PCR reaction for every bacterial species that could possibly be present in the sample. This might actually become possible in the future by the development of “PCR on a chip”, meaning small boards containing hundreds or thousands of small wells or capillaries, each containing the reagents necessary to perform one specific PCR reaction. This technology is still not available, and to our knowledge there are several challenges still to be solved before it will come into commercial use. The use of PCR today is limited to the detection of one specific bacteria, e.g. in case of a clinician suspect tuberculosis in a HIV patient with excessive cough and bloody sputum. If the PCR reaction is positive, you have got your answer. If it is negative, you have no answer.

Identification by sequencing has the power to overcome this problem. This technology detects any bacterial DNA in a sample and gives you the exact nucleotide sequence of a predefined unique section of it. The bacteria can then be identified by matching this nucleotide sequence to a database of known bacterial DNA sequences. The use of sequencing directly from clinical samples could potentially eliminate the need for cultivation for identification and gives the doctors a more reliable identification within one working day. However, its use is greatly limited by the fact that a patient sample very frequently contains more than one bacterial species. Today's sequencing analysis software is not capable of handling the degenerate (mixed) sequences resulting from these samples. As a consequence, one has to cultivate and separate the different bacterial cultures manually prior to sequencing, loosing the potential time benefit and the possibility to identify dead and demanding species. Thus, identification is still a matter of days and may even be a matter of weeks for identification of slow growing bacteria.

Wildenberg et al. (Deconvolving Sequence Variation in Mixed DNA Populations, Journal Of Computational Biology, 10 (2003), p. 635-652) describes an approach to identify sequence variants in a mixed DNA population from sequence trace data. The heart of the method is based on parsimony: given a wild type DNA sequence, a set of observed variations at each position collected from sequencing data, and a complete catalogue of all possible mutations, determine the smallest set of mutations from the catalogue that could fully explain the observed variations.

Wildenberg et al., partly describes a non-flexible, vulnerable algorithm that used together with specific primers can detect different mutations in a gene within a heterogeneous population of the same species. The method is dependent upon a solution set that includes the exact mutations present in the sample. The article does not mention bacteria, fungus or species identification once.

For better prospects of patients, a quick and correct diagnosis of bacterial or fungal infections is desired and therefore, it is of great importance to swiftly and reproducibly be able to identify the different bacteria present in samples containing mixed nucleic acid populations.

### SUMMARY OF THE INVENTION

It is an object of the invention to provide identification of individual sequences from a mixed nucleic acid population. The main advantage of the invention being that it makes such identification possible without prior cultivation and separation of the nucleic acid population. The invention can thereby be used to save enormous amounts of time and resources, and allow for faster treatment of patient to save lives.

The mixed population of nucleic acids may e.g. be obtained from a sample provided from a patient with a suspected infection and consequently, the method will allow the determination of which bacteria has infected the patient. From the mixed population of nucleic acids, a degenerate query sequence is obtained by sequencing and base-calling. The degenerate query sequence is divided into degenerate subsequences from which distinct query subsequence combinations are determined. Then, the similarity between each query subsequence combination and portions of selected target sequences present in a database is determined. The target sequences present in the database are thereby assigned an overall score which is used to determine which individual sequences were present in the mixed nucleic acid population, e.g. determine which bacteria infected the patient. In related embodiments, the invention is implemented by a method or an algorithm, a program or an apparatus.

The method or algorithm has a number of advantages, some of which may be related to specific embodiments, e.g.:
Can be used together with broad-range primers to decode any mixed DNA population.
Can be used together with a broad-range PCR to separate different species, e.g. different bacteria/fungus in a mix.
Will tolerate single and sets of deletions, insertions and substitutions—both in input sequence and solution sequences. This is advantageous in species identification from a mixed bacterial population, because otherwise every possible—not only known—mutations would have to be included for every bacteria in the solution set. Given a sequence length of typically 500 base pairs and 1500 different bacteria, this would most likely turn out to be practically impossible.
Is able to handle a large proportion of ambiguous bases without rejecting the sequence. This in contrast to other algorithms (BLAST, FASTA), that scores ambiguous bases lower than non-ambiguous bases and second will drop possible answers that fall under a predefined score.
Uses a solution set containing only the major clones of relevant bacteria, not all possible mutations for every species.
The solution set does not need to contain all known or possible mutations of the relevant bacteria to function in a clinical setting.

Thus, in an embodiment of the first aspect, the present invention provides a method of identifying individual sequences from a degenerate query sequence obtained by sequencing of a mixed nucleic acid population, said method comprising:
a. providing a degenerate query sequence of length L from the mixed nucleic acid population;
b. providing a database of target sequences;
c. dividing the degenerate query sequence into query subsequences having a length of N bases;
d. for each query subsequence, performing an alignment with least a portion of the target sequences of the database of target sequences; and
e. assigning each target sequence an overall score, wherein the overall score is dependent on the identity between the query subsequences and the aligned portions in the target sequence.

Preferably, the method further comprises presenting a list of target sequences ranked according to their overall scores together with their overall scores. The list need not necessarily present the overall scores of the sequences and may e.g. also be limited to presenting the three 3 best scoring target sequences.

Two different schemes of performing the alignment will be described in the following, and again in more detail in the detailed description: A first embodiment where all possible distinct query subsequences are aligned with and matched against a given portion of the target sequence, and a second embodiment where a portion of the target sequence is matched against a short array of possible combinations for each position in the degenerate query subsequence. In the following, a “degenerate position” is a position in a sequence or subsequence, which has an ambiguity of two or more bases, i.e. where the chromatogram had more than one fluorescent peak with above threshold intensity.

Hence, in a first embodiment, step d comprises generating all possible distinct query subsequences and individually aligning each distinct query subsequence with at least a portion of each target sequence to determine an identity. More specifically, step d of the method may preferably comprise:
generating all possible distinct query subsequences corresponding to the possible combinations of bases at each degenerate position in the query subsequence;
aligning each distinct query subsequence with at least a portion of each target sequence; and
assigning the target sequence scores dependent on the identity between the each distinct query subsequence and portions in the target sequence.

In the second embodiment, step d comprises aligning a portion of the target sequence with all combinations of a query subsequence in one step, i.e. simultaneously. In other words, the portion of the target sequence is directly aligned with a degenerate query subsequence. More specifically, step d of the method may preferably comprise:
aligning the query subsequences directly with a least a portion of the target sequences, wherein the query subsequence may be a degenerate subsequence

Thus, if a position of the query sequence is degenerate, e.g. two bases G and C, the same position can score by alignment with different target sequences comprising a G or C in that particular position. This alignment scheme is demonstrated in more detail in the detailed description.

For the purpose of simplicity and increased speed, it may be advantageous to represent the combination of bases at each degenerate position in a query subsequence by a mask number, so that the simultaneous alignment comprises determining whether a base in the target sequence portion is comprised by the combination of bases represented by the mask number of the corresponding degenerate position in the query subsequence.

Thus, for both alignment schemes, first and second embodiment, all possible query subsequence combinations corresponding to the bases at degenerate positions in the degenerate query sequence are considered, and each combination (whether as a several distinct query subsequences or one degenerate query subsequence) is aligned with portions in the target sequence to determine an identity.

In a preferred embodiment, the step of providing the degenerate query sequence comprises a previous PCR process using broad range primers. The benefit of using broad range primers is that they are able to amplify DNA from all (or almost all) species in a smaller or larger group of organisms e.g. all bacteria, all yeasts or all mycobacteria. This means that a sample can be screened for all organisms included in the group against which the primers are directed, e.g. a patient sample can be screened for bacterial DNA using primers directed against 16S DNA. Broad range primers are also chosen so that the area in between the forward and reverse primer contains one or more variable areas. In this way, if the PCR is positive, a more detailed identification can be achieved by sequencing of the amplified product.

More specifically, the step of providing the degenerate query sequence preferably comprises
providing a sample comprising a mixed nucleic acid population;
providing a broad range primer pair that enables amplification of more than one nucleic acid specie of the mixed nucleic acid population;
performing a PCR reaction using the mixed nucleic acid population as template and the broad range primer pair to provide a PCR product comprising a mixed nucleic acid population; and
sequencing the PCR product to provide the degenerate query sequence.

A broad range primer pair as used herein is a primer pair that enables PCR amplification of a different nucleic acid species. I.e. the PCR product will have fixed flanking region corresponding to the sequence of the primers and a central region wherein sequence deviations may be present. Preferably the different nucleic acid species are provided from different micro organisms such as fungus, bacteria or virus or more preferably from different species of fungus, bacteria or virus such that the method can be used to determine which fungus species, bacteria species or virus species are present in the sample. Preferably, the broad range primer pair enables amplification of bacterial or fungal sequences. Hence, in a preferred embodiment, the nucleic acid species can be derived from any micro-organism with the proviso that the micro-organism is not a virus.

Thus, when the different nucleic acids are comprised within a mixed nucleic acid population provided from a mixed population of bacteria, the broad range primers are complementary to sequences that are fixed for at least 2 different nucleic acids of the mixed nucleic acid population, i.e. the broad range primers are complementary to sequences that the bacteria have in common. In a preferred embodiment, the broad range primer pair is complementary to sequences that are fixed for all bacteria species represented in the database of target sequences.

A sequence as used in present context may refer to the sequence of a particular nucleic acid and consequently have a physical meaning. A sequence as used in the present context may also refer to information obtained by sequencing and which do not necessarily have a meaning for a particular nucleic acid. The skilled man will appreciate that a sequence with ambiguities (also termed a degenerate sequence) does not have a physical meaning for one particular nucleic acid, but that it may reflect the physical sequences of more than one nucleic acid.

The terms aligning and alignment refers to the act of comparing the identity of two portions from different sequences, i.e. whether the portions are the same or not. If a portion of a first sequence and a portion of a second sequence to be aligned are of same length, the alignment typically only requires one arrangement of sequences, i.e. with full overlap. If the first sequence is e.g. 5 bases longer than the second sequence, 5 arrangements of sequences can be made and the alignment actually requires 5 sub-alignments (to overlapping portions of the first sequence).

In one embodiment, the alignment is performed such as to include arrangements where the sequences only partially overlap, even when the sequences are of the same length. I.e. the alignment of two sequences of 10 bases where the minimal overlap is one base will in principle include 19 sub-alignments.

As used in the present context, a mixed nucleic acid population is a population of nucleic acids that differ in sequence. Thus, it comprises different distinct nucleic acids that each has a distinct sequence. Obviously, many copies of each distinct nucleic acid may be present.

A degenerate sequence as used in the present context is a sequence that comprises ambiguous positions. A degenerate sequence may be obtained by sequencing a mixed nucleic acid population as some positions of the obtained sequence will be ambiguous. I.e. at some positions, the identity of the base is not discernable, because the sequence was obtained from a mixed nucleic acid population comprising different sequences. Thus, if the mixed nucleic acid population consists of two individual sequences that differ in a certain position, sequencing of the mixed nucleic acid population will give a degenerate sequence where the particular position is ambiguous. Part of the sequence obtained from the mixed nucleic acid population could e.g. read AGTC(T/C)ATT, where the bases in the brackets denote the ambiguity. In this example, position 5 is either T or C. Obviously many such ambiguities may be present in a sequence obtained from a mixed nucleic acid population. An object of the present invention is to determine which distinct nucleic acids are present in the mixed nucleic acid population and thereby e.g. determine which bacteria are present in a sample. In another aspect to be described later, the invention provides a method, a program and a sequencing machine for generating a degenerate sequence from a chromatogram obtained from a mixed nucleic acid population. The chromatogram may be obtained using Sanger sequencing or pyrosequencing. Most preferred is a chromatogram obtained using Sanger sequencing.

A subsequence as used in the present context is a part of a larger sequence. Further, as will be understood, a degenerate subsequence is a part of a larger degenerate sequence.

The term query subsequence combination (or distinct query subsequence) is used for the different possible subsequences in a degenerate sequence. I.e. for the sequence AGTC(T/C)ATT, two distinct subsequence combinations are possible; AGTCTATT and AGTCCATT.

A database of distinct target sequences as used herein is a database that comprises sequences of e.g. bacterial, animal or even plant origin. A “solution set” and a “pre-defined answer file consisting of a list of target sequences” are herein the same as a database of distinct target sequences.

In a preferred embodiment, the database of distinct target sequences comprises the sequences of the nucleic acids present in the mixed nucleic acid population. Thus, if the mixed nucleic acid population was obtained from a bacteria sample, the database will comprise sequences from bacteria, and the database of distinct target sequences is also referred to as a “bacteria list”. Optionally, the database may be restricted to particular genes or genomic regions for better and more facile identification.

By limiting the number (and size) of the target sequences of the target sequence database, the speed and versatility of the method can be improved. The database of distinct target sequences should be generated upon knowledge of which species one can expect to find in the relevant sample. E.g. if the sample comes from a human, the database should contain relevant human pathogens and colonists. If the sample is milk, the database should contain all bacteria known to contaminate milk products and so on. For a human sample, a database would need to contain typically between 500-1500 distinct target sequences. In a preferred embodiment, the database comprises sequences from less than 1000 species, such as from less than 500 species, such from less than 300 or 200 species. In a preferred embodiment, all target sequences are from bacteria or from fungal species, so that a match within a desired genus is achieved. This is especially relevant when the mixed nucleic acid population is believed to originate from bacteria species or fungal species. In some applications, it may be of interest to even further limit the number of target sequences in the database, so that the database comprises sequences from less than 100 species, such as from less than 50 species, such from less than 30 or 20 species. The sequences can be collected from e.g. BLAST, local databases, commercial databases etc.

In a preferred embodiment of the method of identifying individual sequences from a mixed nucleic acid population, the target sequences of the database of target sequences is trimmed for faster alignment, said trimming comprising:
locate a forward primer position in target sequences
locate a reverse primer position in target sequences
trim all bases that are not between the position of the forward primer and the reverse primer, thereby reducing the number of bases in the database of target sequences that is used for alignment
   wherein the forward primer and the reverse primer are those that were used to provide the degenerate query sequence from the mixed nucleic acid population

When referring the forward and backward primer, what is meant are the primers that were used for PCR amplification of the mixed nucleic acid population. Thus, sequences that are not located between the position of the forward and the reverse primer are irrelevant for alignment and can be ignored in the database of distinct target sequences. In other words, bases that are not located between the forward and reverse primer can be trimmed.

In a preferred embodiment, the position of the forward primer or the position of the reverse primer is used for positional alignment of target sequences and query subsequences, such as to define corresponding positions and corresponding portions of the query sequences and target sequences. I.e. when referring to corresponding positions, correspondence is determined by the position relative to the primer position. Thus, position 10 may refer to the tenths position after the 3′ end of the forward primer counting in the 5′-3′ direction.

In a preferred embodiment, the length N of the degenerate subsequences is between 8 and 25, more preferably between 13 and 20. In another preferred embodiment, the length N of the degenerate subsequence is 13 (+/−1) for mixed nucleic acid populations comprising two nucleic acid species and 20 (+/−1) for mixed nucleic acid populations comprising three nucleic acid species, e.g. representing three different bacterial species.

Increasing N gives improved, discriminating power. Decreasing N increases tolerance for misreading and mutations. A short subsequence increases the speed of the search, and also increases the sensitivity. However, the discriminating power will be lower. A longer subsequence increases the discriminating power, but may in some situations lead to lower sensitivity. It will also decrease the speed of the search.

In another embodiment, the length N of the degenerate subsequence is selected from the group consisting of 5 bases, 6 bases, 7 bases, 8 bases, 9 bases, 10 bases, 11 bases, 12 bases, 13 bases, 14 bases, 15 bases, 16 bases, 17 bases, 18 bases, 19 bases, and 20 bases.

In a preferred embodiment of the method of identifying individual sequences from a mixed nucleic acid population, the length L of the degenerate query sequence is selected from the group of: less than 100 bases, 100-200 bases, 200-300 bases, 300-400 bases, 400-500 bases, 500-600 bases, 600-700 bases, 700-800 bases, 800-900 bases, 900-1000 bases, 1000-1100 bases, 1100-1200 bases, 1300-1400 bases, 1400-1500 bases, and more than 1500 bases. Increasing the length of L will increase the discriminating power of the method. However, the method can handle sequences of any length.

Normally, for species-differentiation of bacteria, the length of L will be between 400-700 bases. However, a length up to 1500 bases may be used to increase the discriminating power. In difficult cases, the length of L may be more than 1500 bases.

The length of L is typically dependent on the expected amount of variability of the individual sequences in the mixed nucleic acid population. Particular genomic regions or genes will often be particularly useful, e.g. genes encoding rRNA. After choosing an appropriate length L, forward and reverse primers can be designed such as to provide the particular length.

The problem of bacterial identification on the basis of a mixed sequence from the 16S gene is the enormous number of possible combinations in relation to the relatively short variable segments upon which discrimination between the possible bacteria is dependent. This is further complicated by the large number of possible real and “artificial” mutations that appear naturally or as a result of errors in the sequencing/base-calling process. As it is not relevant to reduce the number of possible combinations in the degenerate sequence, it is a basic idea behind embodiments of the invention to reduce the number of sequences which the degenerate sequence has to be compared against. This is done by carefully selecting the solution set (target sequences) to contain only relevant information both in order of which species to include and in order of which part of the species DNA to include. In specific embodiments, the query sequence is cut into query subsequences representing all possible combinations within a small part of the degenerate sequence. Then query subsequences are sequentially compared and scored against the solution set. By doing this the increase in number of possible combinations is reduced from an exponential to a linear increase as one move left right along the sequence. As some query subsequences will contain a high proportion of ambiguous bases giving several thousand possible combinations, an unmodified use of this approach will generate a lot of non relevant hits. One possible solution for this could have been the use of a very large query subsequence size, but the size necessary may lead to an unacceptable reduction in sensitivity. Instead, in some embodiments, the primer sequences are used to define an area of interest on the target sequences in the database. The first query subsequence derived from the query sequence will only generate relevant hits in a small portion (window) of size N+n₁+n₂ just after the primer site. Consequently, the search is limited to this window. The window size is slightly larger than the query subsequence size (N) to secure maximum sensitivity in cases of insertions and deletions. For the following query subsequences the window is moved correspondingly.

Hence, a preferred embodiment of the present invention,
wherein the target sequences are divided into search windows of a defined length W≧N, each search window having a core region corresponding to a query subsequence; and
wherein query subsequence combinations are only aligned with portions inside the search window with the corresponding core region.

A search window as used in the present context is used as to refer to a further trimming of the database. In other words, the method is optimized by only aligning a particular query subsequence against a particular search window.

In a further embodiment, the length, W, of the search window is N+n₁+n₂, wherein n₁ is a number of bases on the 5′-end of the portion corresponding to the query subsequence and n₂ is a number of bases on the 3′-end of the portion corresponding to the query subsequence, further, N is the length of the subsequence (distinct or degenerate). N is also the length of the core region of the search window (to be defined below). By using a search window that is larger than the distinct query subsequence it is ensured that one or more deletions and/or insertions (in the distinct query subsequences relatively to the sequences of the database) will not obscure the alignment. When only using the corresponding positions and not a search window that is larger than the distinct query subsequence, a meaningful alignment may be hindered by deletions and/or additions.

In a preferred embodiment, n₁ and n₂ is selected from the group of 1 base, 2 bases, 3 bases, 4 bases, 5 bases, 6 bases, 7 bases, 8 bases, 9 bases, 10 bases, 11 bases, 12 bases, 13 bases, 14 bases, 15 bases, 16 bases, 17 bases, 18 bases, 19 bases, and 20 bases. If many additions and/or deletions are expected, larger n₁ and n₂ should be chosen.

In one embodiment, each query subsequence is aligned with a search window comprising a core region. In effect, this means that the query subsequences overlap to the greatest possible extent and that generation of all possible query subsequences can be done by starting at one end of the degenerate query sequence and then moving the position defining the query subsequence one base at a time.

In one embodiment, the core region is defined as the region corresponding to the query subsequence, wherein correspondence is determined by position relative to the position of the forward or reverse primer.

The start position of the first window preferably depends upon the manual trimming of the query sequence. Based on how much is cut of from the query sequence in the 5 ′-end, the start position may be moved a corresponding number of bases (positions) on the subject sequences in the database. This number of bases is calculated using the following formula: x cut-of value/average peak distance (D). The x cut-of value is the x-value on the chromatogram for the first peak of the trimmed sequence. However, because of the usually poor quality in the beginning of the sequence the average peak distance in the cut away area may diverge considerably from the normal average peak distance D. Consequently, the calculated window start position will only be a rough estimate. To compensate for this, the initial search window may be slightly larger than the subsequent windows, and the starting position for the second window may be adjusted after the highest scoring portion of the initial search window. After this initial adjustment, the start positioning may be considered correct, and the start positions for the subsequent search windows may be set by increasing the position of the preceding window by one. If no match was found for the target sequence in the initial search window, the start position for the subsequent search window may be set to the estimated number of bases (x cut-off value/average peak distance) plus one.

In another embodiment, the position of a next search window is dependent on the highest scoring portion of the previous search window throughout the sequence. Without this dependency, accumulation of more than n₁ or n₂ insertions or deletions (over the length of the target sequence) will obscure a meaningful alignment.

It is to be understood that the position of the next search window will be the position of the core region plus n₁ bases at the 5′-end n₂ bases at the 3′ end of the core region.

When referring to matching bases, what is meant is that the base of a given position of the query subsequence combination is identical to the aligned base of the target sequence. It may be noted that the aligned base is not necessarily at the corresponding position, which is the reason for the use of a search window in some embodiments. Note that when the search window is larger than the length of the query sequence, the alignment includes a number of sub-alignments, only one of which is alignment of corresponding positions.

In one embodiment of the invention
matches for a given aligned query subsequence combination is summarized to produce a sub score, and
the sub score is compared to a threshold score, and
only a sub score over the threshold score is used to assign an overall score to each target sequence.

In a preferred embodiment, the alignment includes a number of sub-alignments.

If the length of the query sequence is e.g. 10 bases, the threshold score may be 8/10 (or 80%) and alignments with only 7 matching bases will not be used to assign an overall score to each target sequence. This is to minimize the effect of fortuitous matches.

In another embodiment, when assigning an overall score to each target sequence, the maximum score that a single base can contribute to the overall score is 1. Thus, the same base of a target sequence may be aligned against different query subsequences, wherein the query subsequences can be overlapping. Also the same base of a target sequence may be used in several sub-alignments. In such a situation, the same base may score several times. Then, as mentioned, in one embodiment, the score of such bases will be normalized such that the maximum score that a single base can contribute to the overall score is 1.

In a still further embodiment, only the highest scoring portion within a search window for a given query subsequence combination can be used to assign an overall score to target sequences. As mentioned earlier each alignment may constitute a number of sub-alignments, each aligning the query sequence combination against a portion of a search window. In this embodiment, only the highest scoring portion will be used to assign an overall score to target sequences, i.e. only the best sub-alignment will count.

In a further embodiment, the overall score of a target sequence is a percentage score calculated by dividing the normalized score of the target sequence by the length L of the target sequence.

In a preferred embodiment, after having assigned overall scores to the target sequences, a preferred embodiment includes the presentation of target sequences with the highest scores to determine the identity of at least some nucleic acids in the population. I.e. the target sequences with the highest overall scores are those most likely to be present in the mixed nucleic acid population. More preferably, the identity of 2, 3 or 4 nucleic acids are determined.

In a preferred embodiment, the mixed nucleic acid population is obtained from a mixed population of bacteria. The mixed nucleic acid population may be purified from the bacteria. More preferably, a broad range PCR reaction is performed using as template the mixed population of bacteria or a mixed nucleic acid population purified from the bacteria. In this embodiment, a presentation of the target sequences with the highest scores will thus allow one to determine with high accuracy which bacteria were present in the mixed population of bacteria.

In a particularly preferred embodiment, the mixed population of bacteria has been obtained from a sample from a human or an animal with a suspected infection. Fast identification of the bacteria present in the sample will then facilitate a swift diagnosis and appropriate treatment, obviously of benefit for the infected human. In similar embodiments, the mixed population of bacteria or fungi has been obtained from a food product with suspected contamination, and similar analysis may provide a fast identification.

In a preferred embodiment, the database of target sequences comprises sequences from Staphylococcus spp., Streptococcus spp., Enterococcus spp., Mycobacterium spp., Enterobacteriacea, Brucella spp., Candida spp., Fusobacterium spp., Bacteroides spp., Prevotella spp., Peptostreptococcus spp., HACEK group bacteria, Actinomyces spp., Haemophilus spp., Pseudomonas spp., Acinteobacter spp., Neisseria spp., Aerococcus spp., Gemella spp., Lactobacillis spp., Eubacterium spp., Listeria spp., Legionella spp., Stenotrophomonas malthophilia, Veilonella, Pasteurella spp., Capnocytophaga spp. etc. The list of bacteria in the solution set does not need to contain all known or possible mutations of the relevant bacteria to function in a clinical setting.

In another preferred embodiment, the target sequences are selected on the basis of which gene one has found suitable to sequence e.g. sequences selected from the group of 16S DNA sequences, 23S DNA sequences, 16S-23S ITS sequences, sodA sequences gyraseB and RecA, rpoB, ITS1 (yeast/fungi), ITS2 (yeast/fungi), 28S DNA (yeast/fungi), or other suitable genes for discriminating between species by sequencing.

The method or algorithm embodiment of the first aspect is preferably carried out by a computer. Hence, in another embodiment, the first aspect of the invention provides a program to be executed by an electronic processor, the program being configured to carry out an algorithm for identifying individual sequences from a degenerate query sequence obtained by sequencing of a mixed nucleic acid population, the program comprising:
means for reading a degenerate query sequence of length L, dividing the degenerate query sequence into query subsequences having a length of N bases, and, for each query subsequence, performing an alignment with least a portion of the target sequences of the database of target sequences;
means for reading a database of distinct target sequences held in storage means accessible to the electronic processor;
means for calculating a similarity between the degenerate query sequence and each target sequence by determining, by alignment, an identity between the query subsequences and at least one portion in the target sequence, and assigning each target sequence an overall score, wherein the overall score is dependent on the identity between the query subsequences and the aligned portions of the target sequence; and
means for generating a list of target sequences ranked according to their overall scores together with their overall scores, and providing said list to an output device.

The program may preferably further comprise software means for carrying out any further steps or providing any further features described in relation to specific embodiments of the method or algorithm in the above.

The program is typically software to be executed by an electronic processor, typically on a computer. The output device may be a display or a printer providing the resulting list to a user, or a network adapter for transmitting the list to another computer such as a server or a network.

The program is preferably used together with broad-range PCR primers to identify bacterial/fungal species in a mix of different bacterial or fungal species. The algorithm preferably applies a database holding a solution set that includes e.g. relevant bacteria, but not necessarily the exact clone present in the sample.

In another embodiment, the first aspect of the invention provides an apparatus configured to identify individual sequences from a degenerate query sequence obtained by sequencing of a mixed nucleic acid population, the apparatus comprising a sequencing machine for providing a query sequence based on DNA sequencing, and a data analysis part for receiving query sequences from the sequence machine, the data analysis part comprising an electronic processor and storage holding the program according to the program embodiment of the first aspect. Preferably, the electronic processor has access to storage means holding a database of distinct target sequences. These storage means need not be part of the apparatus, but may merely be accessible, e.g. via a network connection.

When the sequence machine receives a mixed nucleic acid population for sequencing, such an apparatus will be able to provide a degenerate query sequence and a presentation of the highest scoring target sequences. In a clinical setting, the database may relate to bacteria, and the apparatus will be used to determine which bacteria are present in a sample obtained from a patient.

The program and the apparatus embodiments provided by the first aspect are based on the method embodiment. Therefore, the preferred embodiments, implementations and features described in relation to the method are, where appropriate, equally applicable to the program and the apparatus.

In a second aspect, the invention relates to base-calling and provides a method for generating a degenerate sequence from a chromatogram obtained from a mixed nucleic acid population as defined by claims 29-32, and a corresponding program (claims 33-35) and a sequencing machine (claim 35) for carrying out this method. The degenerate sequence generated by the method, program or sequencing machine embodiments of the second aspect may be used as a degenerate query sequence in the method, program and apparatus embodiments of the first aspect. Thus, embodiments of the first aspect may comprise individual features or elements described in relation to the second aspect.

In a third aspect, the invention is a method for identifying unknown individual bacterial or fungal strains participating in a mixed bacterial or fungal sample using a combination of broad range primers, sequencing and a direct computerized analysis of the resulting mixed chromatogram.

Different implementations of invention according to the third aspect are described in detail in relation to the embodiments presented both in the previous aspects and in the detailed description in the following.

Sequencing is a powerful technology that by the use of broad-range primers are able to multiply and read any bacterial or fungal DNA directly from a clinical sample, i.e. any clinical sample from any living organism (human, animal, fish, etc.) or substance (food, diary products, drinking water, chemicals, drugs etc.) likely to be colonized/infected/contaminated by bacteria or fungus without prior cultivation of the sample. Its use in these settings is however greatly limited by the inability of today's software to decode degenerate sequences i.e. mixed sequences resulting from sequencing a sample containing more than one bacterial or fungal species.

The above solutions are incorporated into a very robust and tolerant search method, referred to as BruteForce, and a very robust and tolerant reading algorithm. It preferably handles all sorts of different mutations without letting them get a disproportionate impact at the final scoring. Because two different bacteria may be present in different concentrations in a sample, sometimes relevant fluorescent peaks will lay close to or within the noise level of the sequence. The BruteForce method may therefore be able to handle a high proportion of ambiguous bases.

### BRIEF DESCRIPTION OF THE FIGURES

In the following, the method, program and apparatus according to the invention will be exemplified and described in detail in relation to a number of embodiments. This description will refer to figures in which:

FIG. 1 is an illustration of a fluorescent marker profile showing a degenerate sequence from a mix of three different bacteria.

FIG. 2 is a flow chart illustrating a simplified version of the program for identifying individual sequences from a degenerate query sequence according to an embodiment of the invention.

FIGS. 3A and B illustrate the Sanger sequencing technology and a resulting sequence.

FIGS. 4-7 are exemplary chromatograms illustrating the present problems of generating a sequence from chromatograms of mixed populations.

FIGS. 8-13 are exemplary chromatograms illustrating the division of a chromatogram into block corresponding to base positions according to an embodiment of the invention.

FIG. 14 is a flow chart illustrating a simplified version of the program for providing a degenerate query sequence according to an embodiment of the invention.

FIG. 15 is an illustration of an embodiment of the apparatus according to various embodiments of the invention.

### DETAILED DESCRIPTION OF THE INVENTION

The method of identifying individual sequences from a degenerate sequence is embodied by some examples of how to carry out the invention.

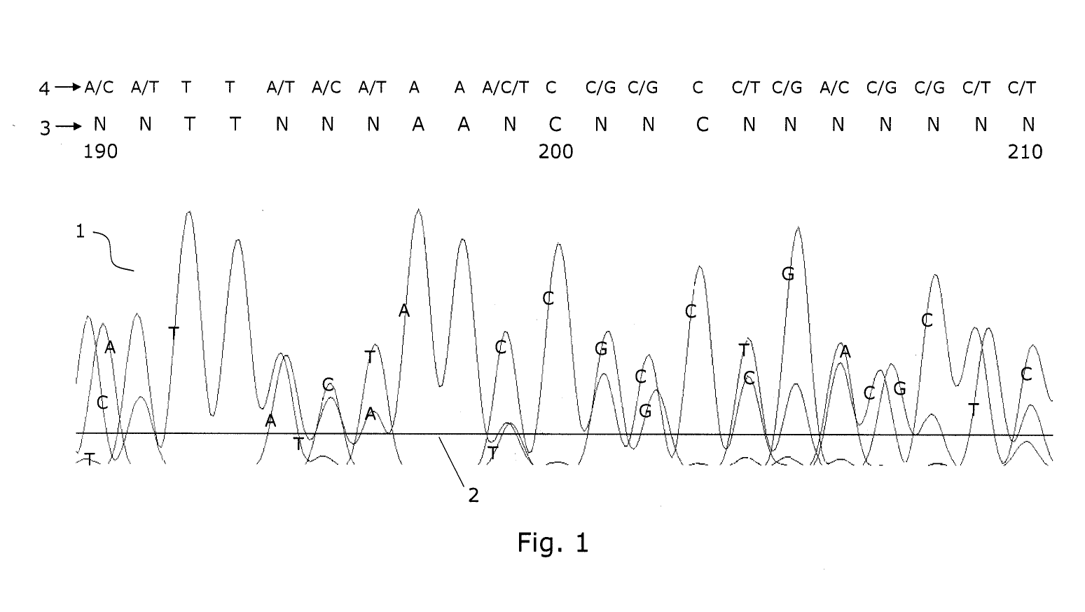

Firstly, however, an introduction to the difficulties in generating a degenerate sequence is given. FIG. 1 shows fluorescent marker profile 1 of a degenerate sequence from a mix of three different bacteria, also referred to as a mixed chromatogram. Each curve in the fluorescent marker profile 1 represents the fluorescence signal from an individual base; C, A, G, or T. Each curve is regularly marked with the corresponding base-letter to facilitate identification in the greyscale figure. Since the sample contains a mix of three different bacteria, there are signals from more than one base showing at each position.

Before you can start to decode the identity of the different bacteria, one first have to decide which of the bases to include in the sequence, i.e. generate the (here degenerate) sequence from the chromatogram, this procedure is commonly referred to as base-calling. In such fluorescent sequence there will typically be some unspecific noise consisting of low fluorescence peaks. Including all of these will increase the risk of getting false answers, and will also slow down the speed of the identification process because of the high number of possible combinations it will create. The user is therefore given the possibility to set a cut off threshold represented by line 2, to remove peaks that are obviously unspecific. Prior art sequence analysis interpret sequences to yield an indefinite base (N) at positions where more than one base has above-threshold fluorescence, resulting in the sequence 3 in FIG. 1.

Second, one has to decide the borders of each position, because the different fluorescent peaks in a specific position are sometimes displaced. E.g. in position 190 in FIG. 1, there is a displacement between the A and the C peaks. If the borders were not set properly the C peak might have been placed in position 189 instead.

In a degenerate sequence there will be more than one possible base at several positions, making room for a number of possible query sequences. In fluorescent marker profile 1 of FIG. 1, there are two bases (A and C) with considerable fluorescence in position 190, giving the possibility of two different query sequences. In position 191 there are again two bases (C and T), raising the total number of possible query sequences to 2×2=4 and so on. Typically one sequences a DNA stretch of 500-1500 bases. If two bacteria in a mixture differ in as few as 30 positions, this will give 1 billion different possible query sequences. To compare 1 billon different sequences of 500 base pair length with a large database like e.g. BLAST is practically impossible, so the challenge is to find ways to make the matching process more efficient.

Instead of the indefinite sequence 3 of FIG. 1, the present invention applies the degenerate sequence 4 as a degenerate query sequence, i.e. the sequence which is used to identify the components in the mixed nucleic acid population. The sequence 4 contains all the information of bases with above-threshold fluorescence signals of the fluorescent marker profile 1. An embodiment of a method for generating a degenerate sequence from a mixed chromatogram, i.e. the base-calling, will be described in detail later in relation to a another aspect of the invention.

### Example 1

In the following, an embodiment of the Bruteforce method or algorithm of identifying individual sequences from a degenerate query sequence obtained by sequencing of a mixed nucleic acid population. Example 1 describes in detail two embodiments of the invention, differing mainly in the procedure of the alignment to determine the overlap between the query subsequences and the target sequences.

The degenerate query sequence to be analyzed in Example 1 (from now on also referred to simply as the query sequence), is a long row of characters—bases. Some positions may contain more than one character (or base) at a time due to the result of the custom file loading process. Multiple characters in a single position are usually the case when there is more than one bacterium in the sample. A query sequence is usually between 400 and 500 bases long. A query sequence resulting from a custom file loading process may look like this, with alternative bases for a position shown in the same column (thus a column corresponds to a position, with different rows in the column containing the different bases with above-threshold fluorescence at the position):

```
C A C G T G C C C T A G T G T A A C G T A T . . . Query subsequence
                C A C G C T
                                                                T
```

It is evident that such degenerate query sequence cannot easily be compared with known sequences due to the degeneracy, i.e. the alternative bases at some positions, caused by sequencing a mixed nucleic acid population.

A pre-defined answer file consisting of a list of target sequences is used which contains sequences of a group of known bacteria. During identification, the query sequence will be compared to these in various ways which will be discussed later.

An answer file composed by pre-sequenced bacteria may look like this:

| | |
|---|---|
| C T G T C G A T G A C G C G T A A C G T A T . . . | Bacteria 1 |
| A T A T C A T C G G T G T T A C A C G T G C . . . | Bacteria 2 |
| C C A T G T A T C T G A C A T C G T A T C G . . . | Bacteria 3 |
| T C G A A T C G T C G A T T G A A C A C A C . . . | Bacteria 4 |
| . . . | . . . |
| . . . | . . . |

This is the list of known sequences against which the various alternatives of the degenerate query sequence will be checked.

To improve speed and accuracy, the method embodied in Example 1 will locate both forward—and reverse primer positions in the target sequences—and trim all bases that are not between the primer positions. The following shows identified locations of forward primer positions in bacteria DNA of the answer file:

| | |
|---|---|
| C T G T C G A T G A C G C G T A A C G T A T . . . | Bacteria 1 |
| A T A T C A T C T G T C G A T C A C G T A C . . . | Bacteria 2 |
| C C A T G T A T C T G A C T G T C G A T C G . . . | Bacteria 3 |
| T C T G T C G A T C G A T T G A A C A C A C . . . | Bacteria 4 |
| . . . | . . . |
| . . . | . . . |

A similar identification is carried out for reverse primer.

All starting positions will be adjusted by removing leading and trailing bases so that all bases in all bacteria are in fact parallel. All query sequences are pre-trimmed this way—only consisting of bases between the primers, so it is given that a position in the query sequence will be the same position in the target sequences—as long as there are no mutations. The resulting target sequences will be faster to compare against:

| | |
|---|---|
| G A C G C G T A A C G T A T A T C T T T C . . . | Bacteria 1 |
| C A C G T A C C T A T T C G G A G A T A C . . . | Bacteria 2 |
| C G A T C G C C T C T A C A G T T A T C T . . . | Bacteria 3 |
| C G A T T G A A C A C A C T C A A T T C A . . . | Bacteria 4 |
| . . . | . . . |
| . . . | . . . |

The search method or algorithm will use one small part of the query sequence at a time—this is called a block or a query subsequence. Here, a block with a size of 7 bases is selected in the query string:

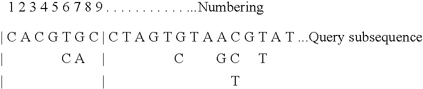

Numbering of the positions in the query sequence allows individual numbering of each block according to the number of its first base—i.e. Block 1 in the above.

Now, detailed descriptions of two different embodiments of procedures for searching for overlap between the degenerate query sequence and the target sequences will be given.

### Alignment, First Embodiment

In the alignment scheme of the first embodiment, all possible combinations of bases for each block are computed, these are the distinct query subsequences. In the above selected block the distinct query subsequences are:

| | |
|---|---|
| C A C G T G C | Block 1, Combination 1 |
| C A C G T A C | Block 1, Combination 2 |
| C A C G C G C | Block 1, Combination 3 |
| C A C G C A C | Block 1, Combination 4 |

Each possible combination within the current block, i.e. each distinct query subsequence, will be aligned with and compared to the corresponding bases at the same position in each bacterium in the list of bacteria. If there are any matching bases, there will be a score of 1 in that position. If the score for the whole block is equal to or higher than a pre-defined threshold, the score will count in the total score.

Starting the scoring process for the first alignment and assignment of score will look as follows:

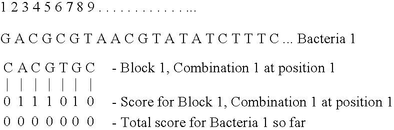

And for the next alignment and assignment of score:

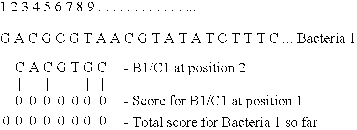

To ease notation, “Block x, Combination y” will be written as Bx/Cy. In none of the above cases did the score for the whole block reach the pre-defined threshold, and the scores did not count in the total score.

All combinations are tried in the same position before moving the comparison position in the target sequences. The comparison position will only be within a pre-defined window, since it is of no use to compare the current combination to the whole bacterium—as one knows the likely position, due to the primer adjustment (trimming). For example, a window of size 13 is defined, and the various block combinations (here Block 5) are only aligned at the various bacteria positions within this window to speed up the process:

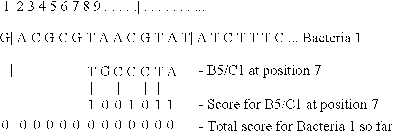

The window will typically be centred at a position corresponding to centre of the query subsequence in the query sequence. In the example, this means that the window is centred at position 8 which is also the centre of Block 5 (with block size=7).

When the comparison within the window for one combination has been completed, the search continues with the next bacteria. When all bacteria have been compared to the current block combination, the whole process is repeated using the next possible combination. After trying all combinations of a block within the corresponding window on all bacteria, the next block is generated, the window is moved correspondingly, and a new aligning procedure is initiated for all combinations of this next block.

In the following, the scoring principle using a pre-defined threshold is demonstrated for Bacteria 2 in the bacteria list.

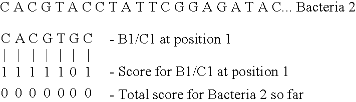

Only when there is a hit over the threshold—here 6—the total score gets updated. The next distinct query subsequence (B1/C2) is aligned:

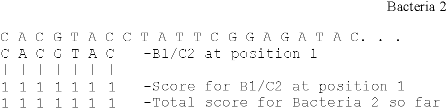

And later, B1/C1 at the next position:

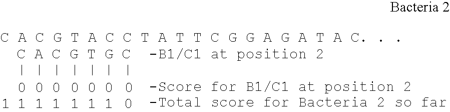

When all combinations in the current block have been tried against all bacteria in the list, the method continues to the next block—moving only one position forward in the query sequence; to query subsequence Block 2:

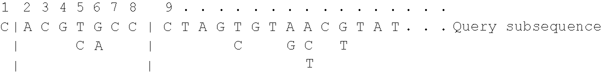

One gets the following distinct query subsequences:

| | |
|---|---|
| A C G T G C C | B2/C1 |
| A C G T A C C | B2/C2 |
| A C G C G C C | B2/C3 |
| A C G C A C C | B2/C4 |

The search then continues, starting in the corresponding window in each bacterium in the list (only alignments for combinations 1 and 2 are shown):

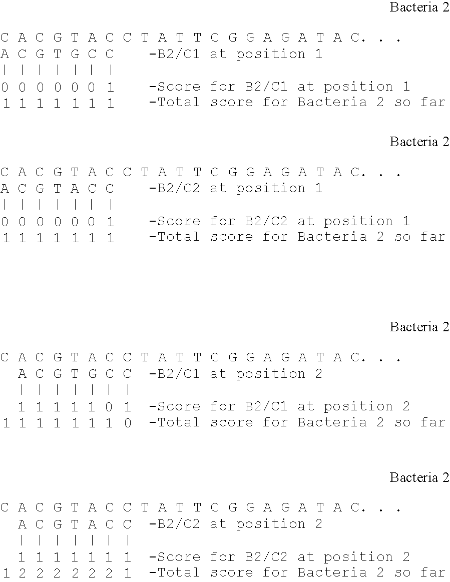

### Alignment, Second Embodiment

The alignment scheme according to the second embodiment is somewhat simpler and thereby faster. Instead of generating all possible combinations within a query subsection (or block) and aligning these with corresponding parts of the target sequences, the parts of the target sequences are matched against a masked query subsequence containing all combinations from the degenerate query sequence. I.e. a degenerate query subsequence is used directly for alignment.

If the degenerate query subsequence is:

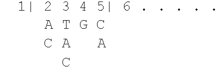

and the corresponding part of the target sequence is:

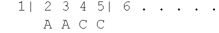

Every letter in the solution sub sequence will be matched against the corresponding column in the degenerate query subsequence. If the letter from is present in the column the score will be set to 1, if not it will be set to 0. The scoring method is similar to that of the first embodiment; if the sum of all scores is equal to, or above the threshold, the whole subsequence will count in the target sequence.

To further improve speed, the base or letter combination in a column can be replaced by a unique number, corresponding to what is referred to as masking in programming.

The possible column or base combinations at a single position are:

### A, T, G, C, AT, AG, AC, TA, TG, TC, GA, GT, GC, CA, CT, CG, ATG, ATC, AGT, AGC, ACT, ACG, TAG, TAC, TGA, TGC, TCA, TCG, GAT, GAC, GTA, GTC, GCA, GCT, CAT, CAG, CTA, CTG, CGA, CGT, and ATGC

Removing duplicates leaves us with 15 possible combinations (as the order of letters in of no importance to the method):

| base combination | mask number |
|---|---|
| A | 1 |
| C | 2 |
| G | 3 |
| T | 4 |
| AT | 5 |
| AG | 6 |
| AC | 7 |
| GT | 8 |
| CT | 9 |
| CG | 10 |
| AGT | 11 |
| ACT | 12 |
| ACG | 13 |
| CGT | 14 |
| ACGT | 15 |

Replacing all columns in the query subsequence with the corresponding mask number:

The degenerate query subsequence was:

A T G C
C A A
C

The new masked query subsequence becomes:
7, 12, 3, 7

Matching a letter from the target sequence against a position in the masked degenerate query subsequence will then be reduced to checking the letter against correct position in a data-array containing the 15 possible combinations. Scoring the first position in the solution set sub sequence “AACC” against the input sub sequence 7, 12, 3, 7 will result in the logical expression: IS “A” IN combinations_array [7]. If the answer is yes, a score of 1 is assigned, of, a score of 0. In an example similar to the examples given in relation to the first embodiment:

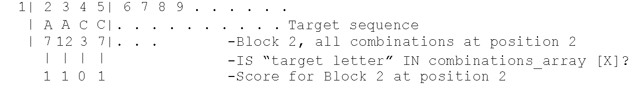

Thus, in the second embodiment, the step of determining an identity between degenerate query subsequences and an aligned portion in the target sequence is carried out for several combinations at once.

As for the first embodiment of the search method/algorithm, blocks are moved around in the query sequence and scores for each target sequence are accumulated.

### Scoring

After exhausting all blocks, all combinations and all windows, the score for each bacterium will be made up of scores from only combinations that have matched very well—above the threshold.

```
G A C G C G T A A C G T A T A T C T T T C . . . Bacteria 1
0 0 0 0 0 0 0 0 0 0 0 0 0 0 1 0 0 1 1 2 0 . . . Total score
C A C G T A C C T A T T C G G A G A T A C . . . Bacteria 2
1 2 3 4 5 6 7 7 7 7 7 7 7 7 7 7 7 7 7 7 7 . . . Total score
                                            ... ...
                                            ... ...
```

Only bases that have a score will count. All bases with 0 score will still be 0. In a preferred embodiment, scores are normalized before they are compared, meaning that all bases with a score of more than 0 will be set to 1.

```
G A C G C G T A A C G T A T A T C T T T C . . . Bacteria 1
0 0 0 0 0 0 0 0 0 0 0 0 0 0 1 0 0 1 1 2 0 . . . Total Score
0 0 0 0 0 0 0 0 0 0 0 0 0 0 1 0 0 1 1 1 0 . . . Normalized score
C A C G T A C C T A T T C G G A G A T A C . . . Bacteria 2
1 2 3 4 5 6 7 7 7 7 7 6 6 6 6 0 6 6 6 7 7 . . . Total Score
1 1 1 1 1 1 1 1 1 1 1 1 1 1 1 0 1 1 1 1 1 . . . Normalized score
                              ... ...
                              ... ...
```

Computing the percentage score will then be the simple task of just dividing the accumulated normalized score (i.e. the number of bases with a score) by the total number of bases in the bacterium (Number of bases between the forward and the reverse primer).

```
G A C G C G T A A C G T A T A T C T T T C . . . Bacteria 1
0 0 0 0 0 0 0 0 0 0 0 0 0 0 1 0 0 1 1 2 0 . . . Normalized score = 23
                                                                                                Total # bases = 435
                                                                                                % score = 23/435 = 5.28%
C A C G T A C C T A T T C G G A G A T A C . . . Bacteria 2
1 1 1 1 1 1 1 1 1 1 1 1 1 1 1 0 1 1 1 1 1 . . . Normaliazed score = 421
                                                                                                Total # bases = 454
                                                                                                % score = 92.73%
                            ... ...
```

The bacteria list is then presented with the corresponding percentage score and should be interpreted as follows:

### Interpretation of Results

The result of the analysis will be presented as a list with the highest scoring subjects on top. The challenge is to decide which ones and how many to include in the answer.

Close inspection of the chromatogram will usually give an indication about how many. Only single and double peaks indicate a mix of two different bacteria, whereas a mix of three different bacteria usually gives triple peaks in at least some positions. We do not believe that it is possible to distinguish between more than three different bacteria with this method.

As of today we operate with an empirically sat cut-off value of ≧99.3% allowing two mismatches per sequence. Subjects with a lower score than this are not taken into consideration (Rule 1). For different DNA sequences and for different origins of mixed nucleic acid population (e.g. bacteria or fungi), the cut-off value can be different, and will typically be selected empirically.

If the answer includes two bacteria from the same genus, both over 99.3%, only the highest scoring species is usually chosen, although it can not be excluded that both are present (Rule 2). This rule is also applied on bacteria from different genus's known to have very similar 16S genes e.g. Citrobacter/Enterobacter/Klebsiella spp. or Eikenella corrodens/Kingella denitrificans. Based upon the present experience with the method, the finding of two bacteria with a homology in the sequenced area >95% should be interpreted with caution. Typically they will be easy distinguishable if they are the only bacteria present in the mix, but if together with a third bacteria only the one of them with the highest score should be accepted.

If the sequence is clearly mixed, but the answer yields only one bacterium, the most likely reason is that the applied database does not contain the remaining sequence. By manually subtracting the signals from the identified bacteria in all ambiguous positions over a short section of the sequence, the rest-sequence can be used to perform a regular BLAST search. The most relevant hits from this search can then be included in the solution database, and the sequence reanalyzed. This method will only function for sequences containing two bacteria. Another possible reason is that the sequence actually contains no more that one bacterium, but that some of it's 16S gene copies has been subjected to deletions or insertions creating the appearance of a mixed sequence.

### Example 2

This example illustrates how the method may be employed in a clinical setting. A 42 year-old man was admitted to the hospital. He was seriously ill with incipient septicaemia and severe back pain. The doctor in the emergency room suspected a pyelonefritis (infection in the kidney), collected urine and blood samples for cultivation and started with broad spectrum antibiotics. The next day this diagnosis is abandoned and the patient is found to have a lumbar spondylodiscitis (infection of the spine), a condition that requires a least 8 weeks of antibiotic treatment. An urgent CT guided biopsy is performed and a sample from the infected bone sent to the Department of Microbiology for cultivation and bacterial identification. Unfortunately, the sample grows nothing, probably because of the administration of antibiotics prior to the procedure. In an effort to avoid eight weeks of “blind”, very broad spectrum expensive antibiotic treatment, one decides to run a 16S sequence analysis directly on the bone sample. One successfully detects bacterial DNA, using primers amplifying the first 500 bases of the 16S rRNA gene, but unfortunately the sequence is degenerate and not interpretable by standard sequence analysis methods.

The Sequence Decoder software easily decodes the sequence and matches it against a database containing the 16S rRNA sequences of 1500 relevant human pathogens e.g. Staphylococcus spp., Streptococcus spp., Enterococcus spp., Mycobacterium spp., Enterobacteriacea, Brucella spp., Candida spp., Fusobacterium spp., Bacteroides spp., Prevotella spp., Peptostreptococcus spp., HACEK group bacteria and Actinomyces spp. The search gives the following scoring list:

Escherichia coli 99, 9%
Staphylococcus epidermidis 99, 8%
Staphylococcus capitis 99, 7%
Staphylococcus homins 99, 5%
Proteus mirabilis 98, 7%
Staphylococcus aureus 97, 8%
Klebsiella pneumoniae 93, 6%
Pseudomonas aeruginosa 82, 6%

Based on this scoring list it is clear that the sample contains an Escherichia coli bacterium. It is also clear that it contains a Staphylococcus species, but it is not evident whether this is a S. epidermidis, S. capitis or S. hominis. The 16S-rRNA gene is very similar among the Staphylococcus species, making it impossible to differentiate them also with sequencing of pure isolates (i.e. non degenerate sequences). To solve this problem one chooses to sequence another more suitable gene for Gram positive cocci (streptococcus spp., Staphylococcus spp), e.g. the SodA gene.

The bone sample was sequenced again, this time using primers for the SodA gene. The resulting degenerate sequence was matched with a SodA database, giving the following scoring list:

Staphylococcus capitis 100%
Escherichia coli 99, 8%
Proteus mirabilis 99, 5%
Klebsiella pneumoniae 99, 4%
Staphylococcus epidermidis 96, 8%
Staphylococcus homins 94, 5%

Using the SodA gene it is seen that S. capitis is clearly the most likely Staphylococcus spp. to be involved. As illustrated the SodA gene is not very suitable for identifying Gram negative rods (E.g. Escherichia coli, Proteus mirabilis, Klebsiella pneumoniae), but this has already been done with the use of the 16S-rRNA gene.

S. capitis is a well known contaminant of clinical samples, and had probably entered the sample because of insufficient sterilisation of the patient's skin before the biopsy procedure. E. coli is a well known human pathogen and a cause of spondylodiscitis. Based on these results, it was possible to narrow the patients antibiotic treatment considerably, saving costs, reducing risk for side-effects and reducing antibiotic pressure on the environment.

To save time, one can run both the SodA and 16S-rRNA analysis simultaneously instead of successively.

To make the scoring list more clearly set up for the inexperienced user, one can group the bacteria known to be difficult to distinguish by the sequencing of the actual gene and add a comment. In the above example one would then get a list looking like this:

Escherichia coli 99, 9%

### Staphylococcus spp 99, 8%

Proteus mirabilis 98, 7%
Staphylococcus aureus 97, 8%
Klebsiella pneumoniae 93, 6%
Pseudomonas aerations 82, 6%

Comment: The sample contains a Staphylococcus spp. For reliable identification, sequencing of the SodA gene is recommended.

In one embodiment, the first aspect of the invention is a computer program, the Bruteforce program, which consists of one or more software modules configured to carry out the Bruteforce algorithm of identifying individual sequences from a degenerate query sequence as described in the above.

The program comprises various means for reading sequences in files and databases and algorithms for performing logical and mathematical operations, and may be coded in different programming languages, e.g. Visual C# in Microsoft Visual Studio 2005. The functions performed by these individual means are clear from the descriptions provided elsewhere, and they may be embodied in various ways as is apparent for the person skilled in the art of computer programming.

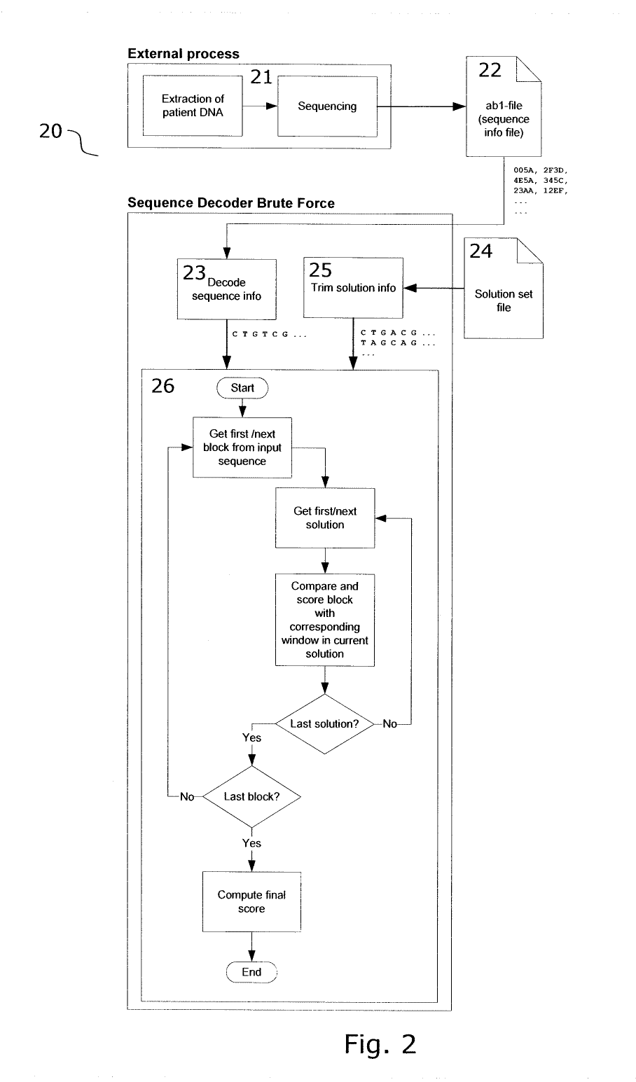

FIG. 2 is a flow chart 20 illustrating the overall architecture of the Bruteforce program. The preparing of samples and sequencing (Block 21) and preparing of a file containing the resulting degenerate sequence (Block 22) are part of an external process which is not part of the Bruteforce program. When having received the degenerate sequence file, the program reads the file and starts the algorithm for decoding the degenerate sequence (Block 23). For this purpose, in order to make the comparison with target sequences, the program has access to a database of target sequences (Block 24) and a trimming step (Block 25) for preparing these for the comparison. Thereafter, the decoding algorithm can be executed (Block 26).

### Base Calling

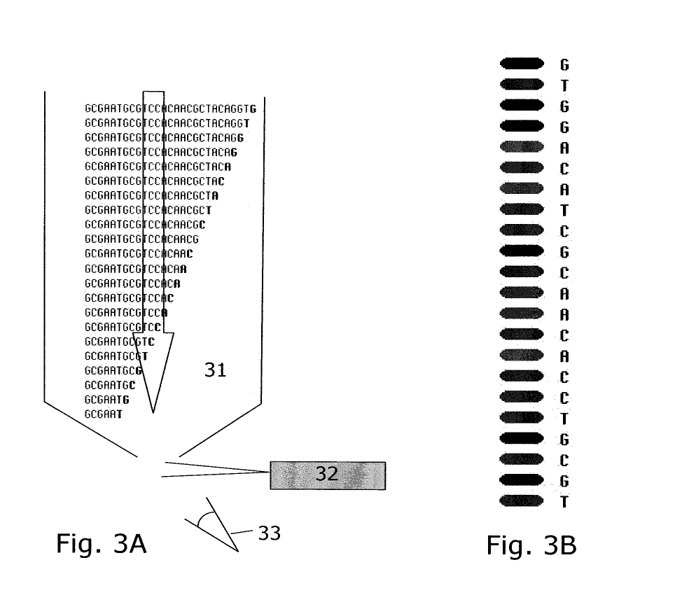

In the following, the method for generating a degenerate sequence from a chromatogram obtained from a mixed nucleic acid population will be described in detail in relation for FIGS. 3-14. This method can be used in an embodiment for providing a degenerate query sequence in the Bruteforce sequence analysis method described previously.

Firstly, a short description of presently used Sanger sequencing technology is given, and the problems related to read sequences from chromatograms from mixed populations will be outlined:

The Sanger sequencing technology:
a. Ordinary PCR-reaction multiplying the part of the DNA that one wishes to sequence.
b. Cyclus-PCR: In this reaction the product from the first PCR is used as target. A small portion of the nucleotides (A,T,C,G) are substituted by modified nucleotides (Am, Tm, Cm, Gm). The incorporation of a modified nucleotide into a novel DNA string being synthesized will immediately terminate further DNA synthesis. Since the incorporation of the modified nucleotides is completely arbitrary in the end one will have a mix of DNA strings of all possible lengths, the last nucleotide incorporated always being a modified nucleotide (FIG. 1).
c. The four different modified nucleotides are also marked with different fluorescent groups, making it possible to detect witch nucleotide that terminated a sequence of a given length.
d. This is done by running the product from the cyclus-sequencing reaction through a capillary gel. A short fragment will move faster through the gel than longer fragment. At the end of the capillary there is a laser detecting the fluorescent signal at the end of the different fragments (FIG. 2).
e. The resulting sequence of different fluorescence signals will correspond to the nucleotide sequence in the target DNA string (FIG. 3).

If the target from an ordinary PCR reaction is:

GCGAATGCGTCCACAACGCTACAGGTG

Then the resulting mix of DNA fragments of (almost) all possible lengths from cyclus PCR is:

GCGAATGCGTCCACAACGCTACAGGTG
GCGAATGCGTCCACAACGCTACAGGT
GCGAATGCGTCCACAACGCTACAGG
GCGAATGCGTCCACAACGCTACAG
GCGAATGCGTCCACAACGCTACA
GCGAATGCGTCCACAACGCTAC
GCGAATGCGTCCACAACGCTA
GCGAATGCGTCCACAACGCT
GCGAATGCGTCCACAACGC
GCGAATGCGTCCACAACG
GCGAATGCGTCCACAAC
GCGAATGCGTCCACAA
GCGAATGCGTCCACA
GCGAATGCGTCCAC
GCGAATGCGTCCA
GCGAATGCGTCC
GCGAATGCGTC
GCGAATGCGT
GCGAATGCG
GCGAATGC
GCGAATG
GCGAAT

Every fragment of a given length will be terminated by the same modified nucleotide.

As Illustrated in FIG. 3A, the DNA fragments in the mix are then run through a capillary gel 31. In the passing through the gel, a fragment of length X will use shorter time than a fragment of length X+1.

At the end of the gel the fluorescent signals of the terminating nucleotides are detected using a laser 32 and fluorescence detector 33, resulting in a sequence of fluorescent signals (FIG. 3B) that corresponds to the sequence of bases (nucleotides) in the target DNA string. In the example shown in FIG. 3B, Am is green, Gm is black, Cm is blue and Tm is red.

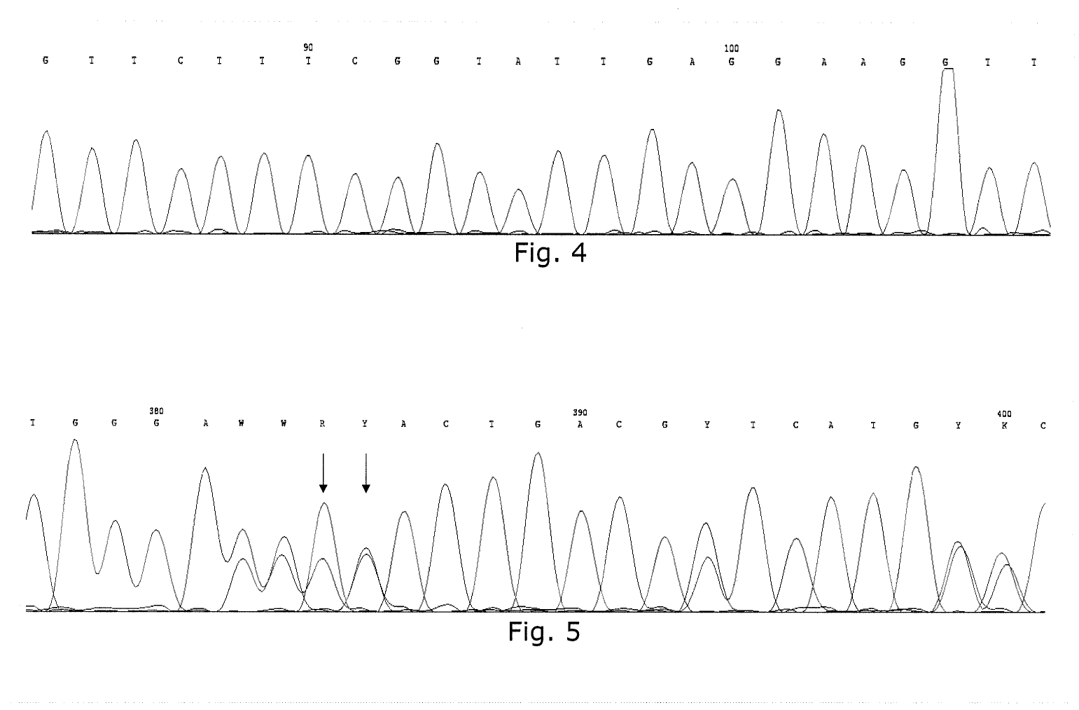

Present automated sequencing machines are displaying the fluorescent signals as a chromatogram also illustrating the relative intensity of the different signals, such chromatogram is shown in FIG. 4 for a section of the present sequence.

When sequencing a mix of two (or more) different bacteria, there will be a mixed fluorescence signal in the positions where the two sequences have different nucleotides. Such mixed chromatogram is shown in FIG. 5, where the arrows indicate exemplary positions with mixed fluorescence signals.

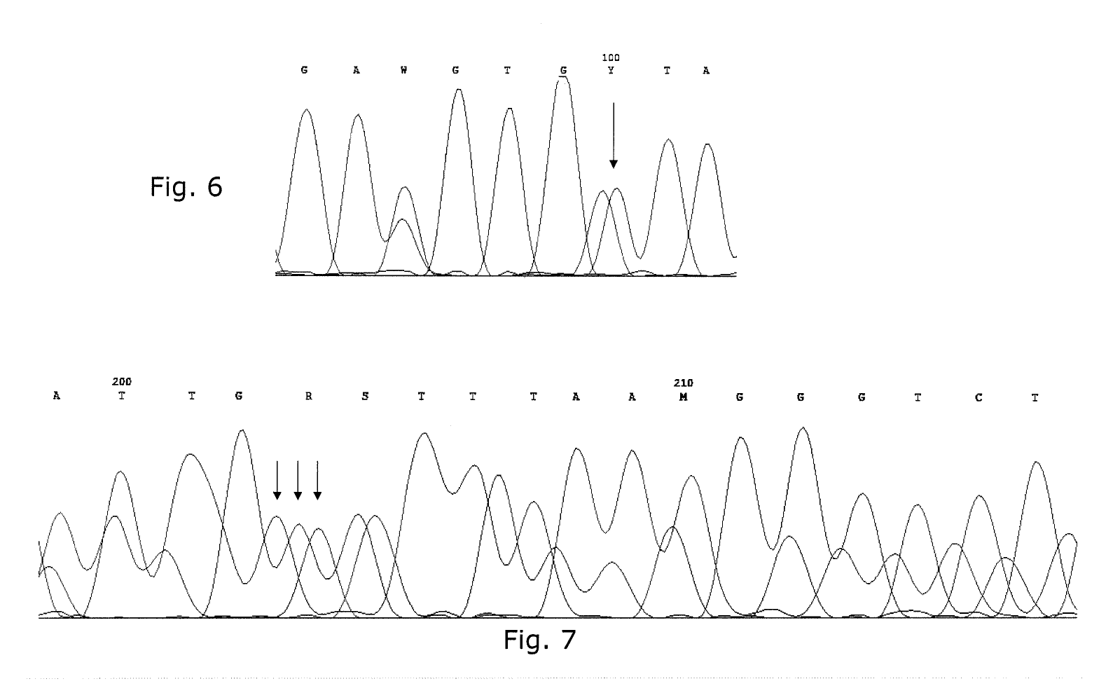

However, since the speed of a fragment through the gel is not only dependent upon its number of nucleotides (length), but also, to some degree, of its electrical charge and nucleotide sequence one will have situations were a fragment from bacteria A with length X travel with a slightly different speed than the corresponding fragment of length X from bacteria B. This will lead to a relative displacement of the fluorescent peaks in the given position as indicated by the arrow in FIG. 6.

The reading algorithm should therefore be able to distinguish between a base displacement and a true new base position. If the displacement is large enough it can be impossible to decide whether a signal from bacteria A corresponds to the signal in position X or in position X+1 in bacteria B, this is illustrated by the arrows in FIG. 7. One can also have situations were the displacement is so large that the fluorescence signal from bacteria A in position X is closer to position X+1 or X−1 in bacteria B. The degree and relative direction of displacements will fluctuate through the sequence.

An erroneous positioning of a single base will have the same impact as an insertion or deletion on the subsequent alignment procedure. Multiple random misplacements will make subsequent analysis impossible. This present a huge problem and disadvantage of present method for reading sequences from mixed chromatograms.

The solution provided by the aspect of the invention related to reading a degenerate sequence from a mixed chromatogram will be described in detail in the following.

Although the distance between two successive bases can vary largely through a sequence, the average distance D (length (L)/number of bases (B)) is very stable from sequence to sequence. Also, in areas where there is a displacement, positions with identical bases will give fluorescence peaks that lie in between the signals from the contributing sequences. From now on, such peaks are referred to as anchor peaks, an example is indicated by the arrow in the mixed chromatogram shown in FIG. 8. In the reading algorithm an anchor peak is defined as a peak where the distances to the next peak in both directions are longer than a set value. The algorithm will always check if a peak is an anchor peak or not.

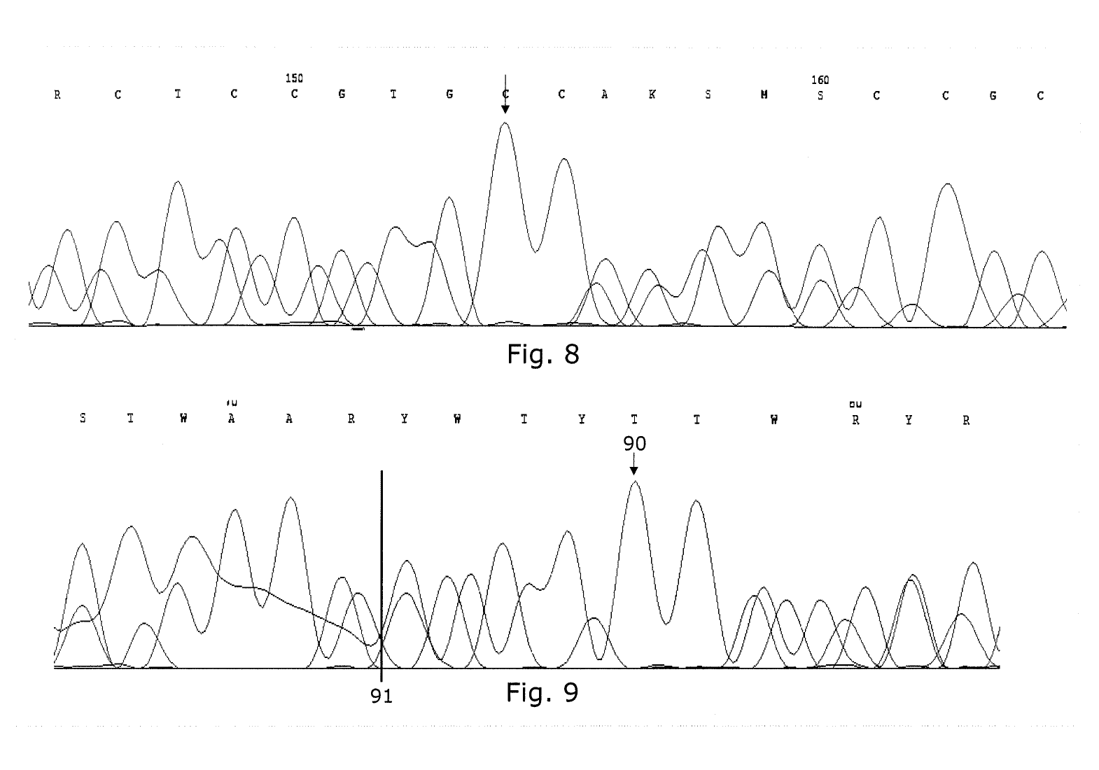

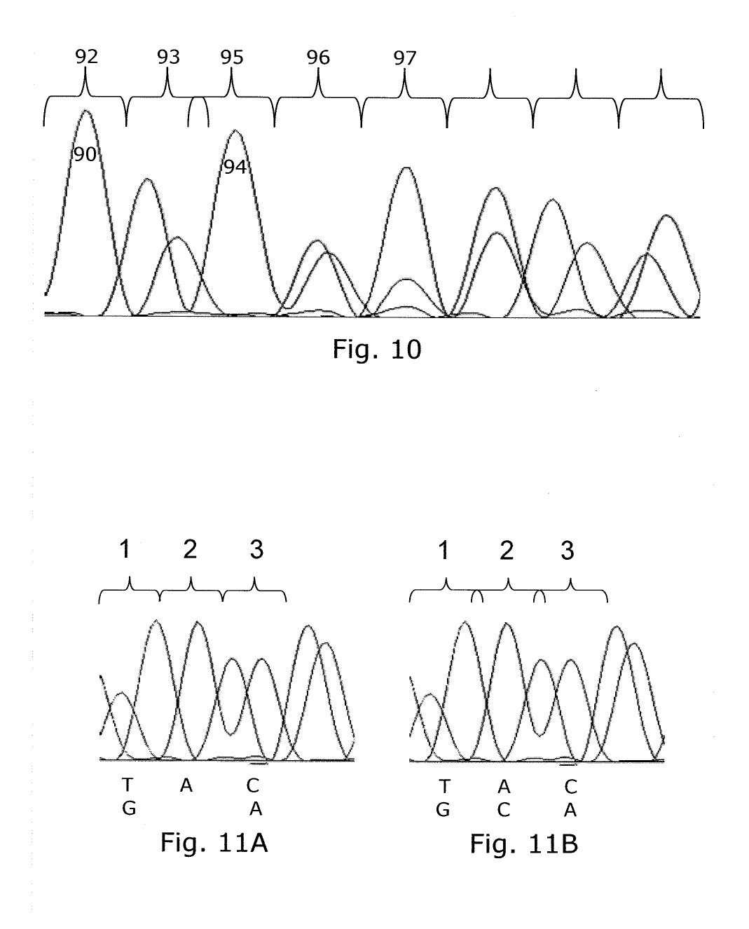

Principally the query sequence is divided into B blocks. The number B is defined as the length L of the query sequence divided by the average base distance D. All fluorescence peaks within a block is decided to belong to the same sequence position. For this to be functional one have to find a suitable starting position for the dividing. As is illustrated in FIG. 9, the position of the first anchor peak 90 after the manually decided left cut (i.e. after trimming of the sequence ends) 91 of the query sequence will define the centre of the first block 92 (FIG. 10).

As illustrated in FIG. 10, the centre of the second block 93 will be at a distance D from the position of the first anchor peak 90, the centre of the third block will be at a distance 2D and so on until a new anchor peak 94 is detected. Then this new anchor peak 94 will be sat as the centre of a new first block 95, and a new starting point for calculating the subsequent block centres 96, 97 etc.

To sum up, dividing the mixed chromatogram into B blocks of equal size can be performed according to an algorithm as outlined in the below. Initially, a first anchor peak in the chromatogram from a left cut-off position is identified, and an average peak distance D is determined. Thereafter, dividing the chromatogram into B blocks is carried out using the following algorithm:
aligning a first block 92 so that its centre coincides with the first anchor peak 90;
aligning additional n blocks (e.g. block 93) to the right of the first block so that their centres are spaced a distance nD from the centre of the first block, under the proviso that whenever a new anchor peak 94 is encountered, the block 95 covering the position of the new anchor peak is re-aligned so that its centre coincides with the new anchor peak, and additional blocks to the right (blocks 96 and 97) are aligned so that their centres are spaced a distance nD from the centre of the block 95 covering the position of the new anchor peak 94;

As a control mechanism, the algorithm can, when a new anchor peak and starting point is detected, perform a backward control of the reading performed with basis in the preceding anchor peak. For this part of the sequence, if the backward reading is identical with the forward reading, the reading is accepted. If not, the forward reading will be accepted for the first half being closest to the preceding anchor peak, and the reverse reading will be accepted for the last part being closest to the new anchor peak. The rationale for this is that reading is most likely to be correct close to an anchor peak. In addition, the area in between two anchor peaks were the forward and reverse reading has been different will be marked in the software, so that the user can, if he finds it necessary, manually control the reading in this area.

To preserve sensitivity in areas with large displacements it can be necessary to let the blocks overlap i.e. let the block size be larger than the average base distance D. Consequently, the bases of uncertain position, meaning bases with peaks very close to the border of a block, will be counted in both possible positions. This is illustrated in FIGS. 11A and B which are examples of a short sequence being read with and without block overlapping and the resulting read degenerate sequences.

This approach assures that the base is placed in the right position and consequently maximum score for the bacteria actually present in the mix. However, it also places the base in the wrong position. This may lead to decreased specificity if, by chance, the incorporation of a base in an extra position leads to a better score for a bacteria not present in the mix.

Choosing not to overlap will lead to wrong positioning of displaced bases and a lower score for bacteria present in the mix. As a consequence the final score might fall under the cut-of value giving a lower sensitivity. In addition you would still have the possibility for incidental higher scores for bacteria not present. When it comes to differentiate between genetically similar bacteria, the impact of loosing a true match in the bacterium present will be identical of gaining a false match in the bacterium not present.

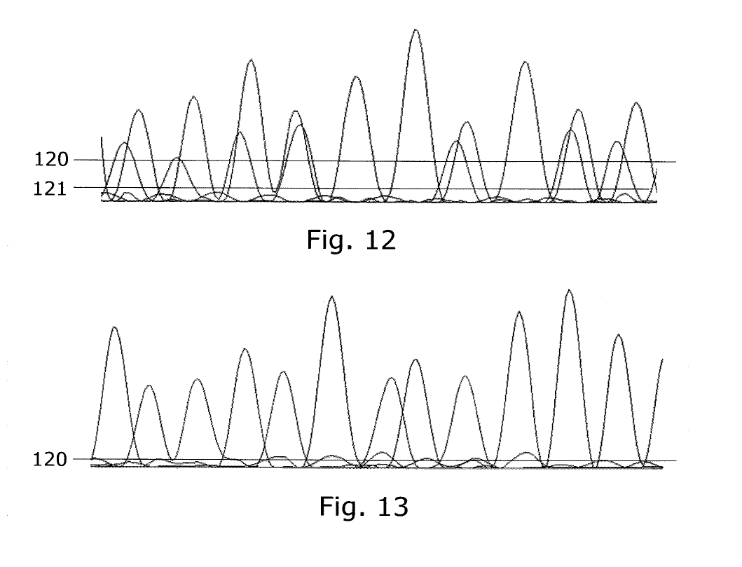

In a chromatogram there will typically be some noise, i.e. low signals not representing true bases. Including these in the reading will decrease the specificity of the method. When sequencing single bacteria, this problem can be solved by always picking only the highest peak in a given position. When sequencing mixed sequences this approach can not be used, since there will be more than one true hit in a proportion of the positions. A peak cut-off value or threshold intensity 120 can be used to solve this. The cut-off value 120 is set manually based on visual inspection of the respective chromatograms. In samples where the different bacteria are present in similar amounts, the cut-off value 120 can normally be set far above the noise level 121 (FIG. 12). In samples were one of the bacteria is present in a significantly lower concentration, the relative signal intensity from this bacteria will be weaker, and the cut-off value 120 value will have to be set lower (FIG. 13).

In one embodiment of the second aspect, the invention provides a computer program for carrying out the method for generating a degenerate sequence from a mixed chromatogram. Such program consists of one or more software modules configured to carry out this method as described in the above.

The program comprises various means for analysing data representing a chromatogram, algorithms for performing logical and mathematical operations as indicated by the method, and means for presenting the generated degenerate sequence for further analysis, e.g. by storing or transmitting the sequence. The functions performed by these individual means are clear from the descriptions provided elsewhere, and they may be embodied in various ways as is apparent for the person skilled in the art of computer programming.

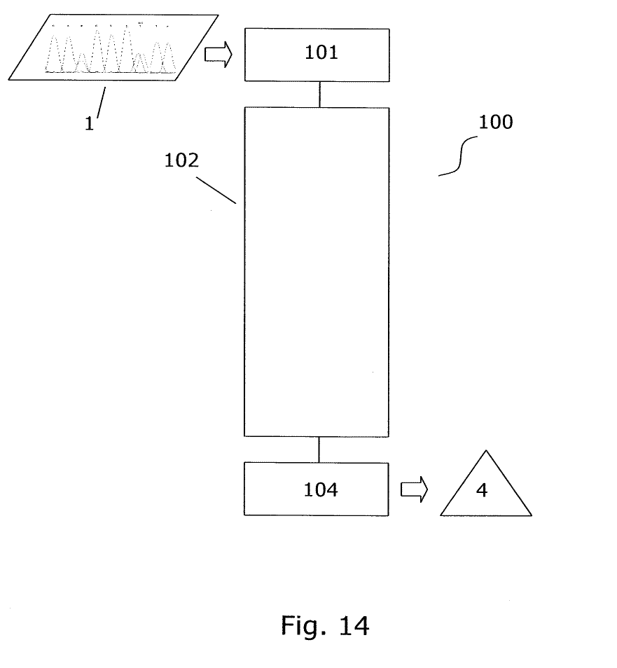

FIG. 14 is a flow chart 100 illustrating an overall architecture of the computer program for generating a degenerate sequence from a mixed chromatogram. The program is an embodiment of the preparing of a file containing the degenerate sequence of Block 22 in FIG. 2. First, Block 101 receives a chromatogram 1 comprising fluorescent signals obtained by an automated sequencing machine from a mixed nucleic acid population. In Block 102, an algorithm divides the chromatogram into B blocks of equal size, where B is the number of base positions in the degenerate sequence. An embodiment of such algorithm has been described in the above. At last, in Block 104, the fluorescent peaks in each block are registered and related to a base according to its colour, leading to a degenerate query sequence 4.

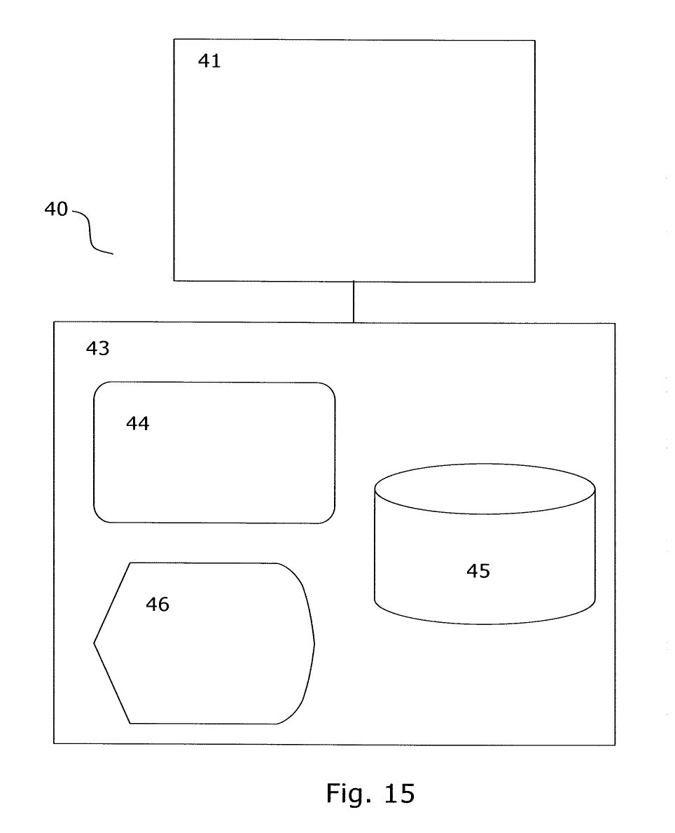

FIG. 15 illustrates an apparatus 40 configured to generate a degenerate query sequence from a chromatogram from a mixed nucleic acid population and to identify individual sequences from a degenerate query sequence obtained by sequencing of a mixed nucleic acid population. The apparatus comprises a sequencing machine 41 for providing a query sequence based on DNA sequencing of a sample. The sequencing machine may e.g. be a 3730 DNA Analyzer (Applied Biosystems) or a 3100 Genetic Analyzer (Applied Biosystems). The sequencing machine 41 is connected to a data analysis part 43, typically a computer, which is possibly integrated in the sequencing machine 41. Thus data analysis part 43 comprises an electronic processor 44 and storage 45 adapted to execute and hold the program for generating a degenerate query sequence described in relation to FIG. 14 and the Bruteforce computer program described in relation to FIG. 2.

In an alternative, one or both of these programs may be held and executed by the sequencing machine itself. The data analysis part 43 can receive a file containing the query sequences determined by the sequencing machine or as an output from the program for generating degenerate query sequences, and apply the BruteForce algorithm to determine a list of target sequences ranked according to their overall scores. For this purpose, the processor 44 of the data analysis part 43 has access to storage means holding a database of distinct target sequences, which may be external storage, such as a network server, or which may be incorporated in the storage 45. The apparatus 40 typically comprises an output device 46, such as a display, a printer or a network connection, to present or transmit the determined list.

1. A method of identifying individual sequences from a degenerate query sequence obtained by sequencing of a mixed nucleic acid population, said method comprising:
a. providing a degenerate query sequence of length L from the mixed nucleic acid population;
b. providing a database of target sequences;
c. dividing the degenerate query sequence into query subsequences having a length of N bases;
d. for each query subsequence, performing an alignment with a portion of the target sequences of the database of target sequences, the alignment comprising:
locating a forward and/or reverse primer position in target sequences in the database, wherein the primer is one used to provide the degenerate query sequence from the mixed nucleic acid population;
performing a positional alignment of target sequences and query sequences using the position of the forward and/or reverse primer;
dividing the target sequences into search windows of a defined length W≧N, each search window having a core region with the same position relative to the primer position as a query subsequence;
for each query subsequence, generating all possible distinct query subsequences and individually aligning them only within the search window of each target sequence having a core region with the same position relative to the primer position as the query subsequence; and
e. assigning each target sequence an overall score, wherein the overall score is dependent on the identity between the aligned query subsequences and portions in the target sequence.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. The method of claim 1, wherein the target sequences in the database of target sequences are trimmed for faster alignment, said trimming comprising trimming all bases that are not between the position of the forward primer and the reverse primer, thereby reducing the number of bases in the database of target sequences that is used for alignment.

34. The method of claim 1, wherein the length, W, of the search window is N+n₁+n₂, and wherein n₁ is a number of bases on the 5′-end of the portion corresponding to the query subsequence and n₂ is a number of bases on the 3′-end of the portion corresponding to the query subsequence.

35. The method of claim 1, wherein the step of providing the degenerate query sequence comprises:
a previous PCR process using broad range primers;
providing a sample comprising a mixed nucleic acid population;
providing a broad range primer pair that enables amplification of more than one nucleic acid specie of the mixed nucleic acid population;
performing a PCR reaction using the mixed nucleic acid population as template and the broad range primer pair to provide a PCR product comprising a mixed nucleic acid population; and
sequencing the PCR product to provide the degenerate query sequence.

36. The method of claim 1, wherein step d comprises:
generating all possible distinct query subsequences corresponding to the possible combinations of bases at each degenerate position in the query subsequence;
aligning each distinct query subsequence with at least a portion of each target sequence; and
assigning the target sequence scores dependent on the identity between the each distinct query subsequence and portions in the target sequence.

37. The method of claim 1, wherein step d comprises simultaneously aligning a portion of the target sequence with all combinations of a query subsequence.

38. The method of claim 1, wherein the mixed nucleic acid population is obtained from a mix of different bacteria and/or fungi species.

39. The method of claim 1, wherein the database of target sequences comprises sequences from relevant bacteria or fungi.

40. The method according to claim 1, wherein providing a degenerate query sequence from the mixed nucleic acid population comprises:
receiving a chromatogram comprising fluorescent signals obtained by an automated sequencing machine from the mixed nucleic acid population, the chromatogram thereby representing a degenerate sequence;
dividing the chromatogram into blocks of equal size, each block having a size equal to or larger than the normal average peak distance D in the chromatogram;
generating the degenerate query sequence by assigning a base to each fluorescent peak with above-threshold intensity within each block of the chromatogram according to its colour, where each block corresponds to a single position in the degenerate query sequence and where all peaks with above-threshold intensity within a block gives rise to a base at the corresponding position of the degenerate query sequence.

41. The method according to claim 40, further comprising:
identifying a first anchor peak in the chromatogram from a left cut-off position, an anchor peak being a peak with distances to the nearest peaks with above-threshold intensity in both directions, which are longer than a pre-set distance;
wherein dividing the chromatogram into blocks is carried out using the following algorithm:
aligning a first block so that its centre coincides with the first anchor peak;
aligning additional n blocks to the right of the first block so that their centres are spaced a distance nD from the centre of the first block, under the proviso that whenever a new anchor peak is encountered, the block covering the position of the new anchor peak is aligned so that its centre coincides with the new anchor peak, and additional blocks to the right are aligned so that their centres are spaced a distance nD from the centre of the block covering the position of the new anchor peak;

42. A program to be executed by an electronic processor, the program being configured to facilitate the method according to claim 1 by providing means for performing elements c., d. and e. and being adapted to receive data representing a degenerate query sequence of length L and to access a database of target sequences.

43. An apparatus configured to identify individual sequences from a degenerate query sequence obtained by sequencing of a mixed nucleic acid population, the apparatus comprising a sequencing machine for providing a query sequence based on DNA sequencing, and a data analysis part for receiving query sequences from the sequence machine, the data analysis part comprising an electronic processor and storage holding the program according to claim 42.

44. A method for providing a degenerate query sequence, comprising:
A. receiving a chromatogram comprising fluorescent signals obtained by an automated sequencing machine from a mixed nucleic acid population, the chromatogram thereby representing a degenerate sequence;
B. identifying a first anchor peak in the chromatogram from a left cut-off position, an anchor peak being a peak with distances to the nearest peaks with above-threshold intensity in both directions, which are longer than a pre-set distance;
C. dividing the chromatogram into blocks of equal size, each block having a size equal to or larger than the normal average peak distance D in the chromatogram using the following algorithm:
aligning a first block so that its centre coincides with the first anchor peak;
aligning additional n blocks to the right of the first block so that their centers are spaced a distance nD from the centre of the first block, under the proviso that whenever a new anchor peak is encountered, the block covering the position of the new anchor peak is realigned so that its centre coincides with the new anchor peak, and additional blocks to the right are aligned so that their centers are spaced a distance nD from the centre of the realigned block covering the position of the new anchor peak.
D. generating the degenerate query sequence by assigning a base to each fluorescent peak within each block of the chromatogram according to its colour, where each block corresponds to a single position in the degenerate query sequence and where all peaks within a block gives rise to a base at the corresponding position of the degenerate query sequence.

45. A program to be executed by an electronic processor, the program being configured to facilitate the method according to claim 44 by providing means for performing elements B., C., and D. and being adapted to receive data representing a chromatogram comprising fluorescent signals.

46. A sequencing machine comprising storage for holding the program according to claim 45, and electronic processing means for executing the program using a chromatogram generated by the sequencing machine.


SEQUENCE LISTING (27 sequences)

SEQ ID NO: 1 - DNA, 22 bp, Artificial Sequence
  Oligonucleotide primer
cacgtgccctagtgtaacgtat

SEQ ID NO: 2 - DNA, 22 bp, Artificial Sequence
  Oligonucleotide primer
ctgtcgatgacgcgtaacgtat

SEQ ID NO: 3 - DNA, 22 bp, Artificial Sequence
  Oligonucleotide primer
atatcatcggtgttacacgtgc

SEQ ID NO: 4 - DNA, 22 bp, Artificial Sequence
  Oligonucleotide primer
ccatgtatctgacatcgtatcg

SEQ ID NO: 5 - DNA, 22 bp, Artificial Sequence
  Oligonucleotide primer
tcgaatcgtcgattgaacacac

SEQ ID NO: 6 - DNA, 21 bp, Artificial Sequence
  Oligonucleotide primer
gacgcgtaacgtatatctttc

SEQ ID NO: 7 - DNA, 21 bp, Artificial Sequence
  Oligonucleotide primer
cacgtacctattcggagatac

SEQ ID NO: 8 - DNA, 21 bp, Artificial Sequence
  Oligonucleotide primer
cgatcgcctctacagttatct

SEQ ID NO: 9 - DNA, 21 bp, Artificial Sequence
  Oligonucleotide primer
cgattgaacacactcaattca

SEQ ID NO: 10 - DNA, 27 bp, Artificial Sequence
  Oligonucleotide primer
gcgaatgcgtccacaacgctacaggtg

SEQ ID NO: 11 - DNA, 26 bp, Artificial Sequence
  Oligonucleotide primer
gcgaatgcgtccacaacgctacaggt

SEQ ID NO: 12 - DNA, 25 bp, Artificial Sequence
  Oligonucleotide primer
gcgaatgcgtccacaacgctacagg

SEQ ID NO: 13 - DNA, 24 bp, Artificial Sequence
  Oligonucleotide primer
gcgaatgcgtccacaacgctacag

SEQ ID NO: 14 - DNA, 23 bp, Artificial Sequence
  Oligonucleotide primer
gcgaatgcgtccacaacgctaca

SEQ ID NO: 15 - DNA, 22 bp, Artificial Sequence
  Oligonucleotide primer
gcgaatgcgtccacaacgctac

SEQ ID NO: 16 - DNA, 21 bp, Artificial Sequence
  Oligonucleotide primer
gcgaatgcgtccacaacgcta

SEQ ID NO: 17 - DNA, 20 bp, Artificial Sequence
  Oligonucleotide primer
gcgaatgcgtccacaacgct

SEQ ID NO: 18 - DNA, 19 bp, Artificial Sequence
  Oligonucleotide primer
gcgaatgcgtccacaacgc

SEQ ID NO: 19 - DNA, 18 bp, Artificial Sequence
  Oligonucleotide primer
gcgaatgcgtccacaacg

SEQ ID NO: 20 - DNA, 17 bp, Artificial Sequence
  Oligonucleotide primer
gcgaatgcgtccacaac

SEQ ID NO: 21 - DNA, 16 bp, Artificial Sequence
  Oligonucleotide primer
gcgaatgcgtccacaa

SEQ ID NO: 22 - DNA, 15 bp, Artificial Sequence
  Oligonucleotide primer
gcgaatgcgtccaca

SEQ ID NO: 23 - DNA, 14 bp, Artificial Sequence
  Oligonucleotide primer
gcgaatgcgtccac

SEQ ID NO: 24 - DNA, 13 bp, Artificial Sequence
  Oligonucleotide primer
gcgaatgcgtcca

SEQ ID NO: 25 - DNA, 12 bp, Artificial Sequence
  Oligonucleotide primer
gcgaatgcgtcc

SEQ ID NO: 26 - DNA, 11 bp, Artificial Sequence
  Oligonucleotide primer
gcgaatgcgtc

SEQ ID NO: 27 - DNA, 10 bp, Artificial Sequence
  Oligonucleotide primer
gcgaatgcgt